(19) United States
(12) Patent Application Publication
(10) Pub. No.: US 2026/0260863 A1
(43) Pub. Date: Sep. 3, 2026

(54) DEVICE FOR REACTING ANALYTE IONS WITH ELECTRONS OR REACTANT IONS

(71) Applicant: Micromass UK Limited, Wilmslow (GB)

(72) Inventors: Jeffery Mark Brown, Hyde (GB); Keith George Richardson, High Peak (GB)

(73) Assignee: Micromass UK Limited, Wilmslow (GB)

(21) Appl. No.: 19/163,784

(22) PCT Filed: Mar. 13, 2024
(86) PCT No.: PCT/GB2024/050679

§ 371 Date: Sep. 9, 2025

(30) Foreign Application Priority Data
Mar. 14, 2023 (GB) 2303726.0

(51) Int. Cl. H01J 49/00; H01J 49/06; H01J 49/42

(52) U.S. Cl. CPC H01J 49/0072; H01J 49/062; H01J 49/4245

(57) ABSTRACT

A method of mass and/or ion mobility spectrometry comprising: trapping electrons or reactant ions (3) within a reaction region with DC electric fields; conveying analyte ions (16) into a first side of the reaction region and through the reaction region such that they react with the electrons or reactant ions (3), and allowing the resulting ions (20) to exit the reaction region through a second side of the reaction region that is opposite the first side.

### CROSS-REFERENCE TO RELATED APPLICATION

This application claims priority from and the benefit of United Kingdom patent application No. 2303726.0, which was filed on 14 Mar. 2023. The entire content of this applications are incorporated herein by reference.

### FIELD OF THE INVENTION

The present invention relates generally to a method of mass and/or ion mobility spectrometry in which analyte ions are reacted with electrons or reactant ions so as to produce charge-reduced analyte ions, fragment ions or other product ions. The present invention also provides a mass and/or mobility spectrometer configured to perform the method.

### BACKGROUND

It is well known to conduct ion-electron and ion-ion reactions, in the field of mass spectrometry, during the analysis of analyte ions. Examples of such reactions include electron capture dissociation (ECD) and electron transfer dissociation (ETD). In order to perform ECD, multiply protonated analyte molecules (i.e. analyte ions) are confined along with low energy electrons such that the analyte molecules and electrons react with each other so as to cause the analyte molecules to fragment into daughter ions. Similarly, in ETD multiply protonated analyte molecules are confined along with low energy reactant ions such that the analyte molecules and reactant ions react with each other so as to cause the analyte molecules to fragment into daughter ions. In addition to ETD and ECD, other ion-electron reactions or ion-ion reaction may be used in the analysis of ions, such as electron induced dissociation (EID).

Mass analysis using electron-based fragmentation techniques such those described above are beneficial in that they may be more informative than using other fragmentation techniques, such as collisional induced dissociation (CID), since the product ions produced by the reactions retain labile post-translational modifications. Also, during the above-mentioned ion-electron interactions, some of the analyte molecules may not dissociate into fragment ions but may become charge-reduced instead. Such charge reduction may be useful for separating ions that would otherwise have overlapping charge states, thus enabling confident charge annotation. Also, electron-based fragmentation techniques can generate higher-quality (more complete) or complementary fragment information for polymers such as peptides.

However, although ion-electron and ion-ion reaction devices are known, their design is typically complex and their operation can be challenging, e.g. due to the difficulty in confining the analyte ions and the low energy electrons or reactant ions in the same region for a sufficient time and with sufficient density for the reactions to be performed. For example, ECD devices are known that employ an RF electric field to confine the analyte ions, but this RF field increases the energy of the reactant electrons and so the probability of the analyte ions capturing the electrons is relatively low, and hence so is the probability of a reaction taking place. Other known reaction devices use strong magnetic fields in order to confine the electrons at low energy, but these also present difficulties in confining both the analyte ions and reactant electrons in the same region such that the reactions take place at the required rate.

### SUMMARY

The present invention provides a method of mass and/or ion mobility spectrometry comprising: trapping electrons or reactant ions within a reaction region with DC electric fields; conveying analyte ions into a first side of the reaction region and through the reaction region such that they react with the electrons or reactant ions, and allowing the resulting ions to exit the reaction region through a second side of the reaction region that is opposite the first side.

Confining the electrons or reactant ions within the reaction region using only DC electric fields, enables confinement of the electrons or reactant ions without significantly increasing their energies. This provides a relatively high rate of reaction with the analyte ions, since the electrons or reactant ions have relatively low energies and can be confined for a relatively long duration.

The analyte ions are transmitted into the first side of the reaction region and the ions that result from reactions between the analyte ions and the electrons or reactant ions (along with any unreacted analyte ions) are allowed to exit the opposite side of the reaction region. This is a particularly convenient arrangement for conducting the reactions, which also allows the analyte ions to have a relatively high kinetic energy as they pass through the reaction region such that the trajectories of these ions are relatively unperturbed by space-charge fields formed by the trapped electrons or reactant ions.

The analyte ions may be positively charged ions. In which case these ions may be reacted with the electrons or the reactant ions may be negatively charged ions. Alternatively, the analyte ions may be negatively charged ions. In which case the reactant ions may be positively charged ions. However, it is also contemplated that the analyte ions may have the same polarity as the reactant ions or electrons, e.g. so that the reaction is an electron detachment dissociation (EDD) reaction between negative analyte ions and higher energy electrons.

The analyte ions may react with the electrons or reactant ions such that the analyte ions dissociate to form fragment ions and/or so that the analyte ions become charge-reduced analyte ions. For example, the analyte ions may react with the electrons or reactant ions via ECD or ETD reactions.

Said trapping may comprise trapping the electrons or reactant ions between: (i) at least two electrostatic mirrors; (ii) at least two electrostatic sectors; or (iii) at least one electrostatic mirror and at least one electrostatic sector.

Each electrostatic mirror herein has an opening at one of its ends for receiving the electrons or reactant ions. The mirror also has electrodes and voltage supplies arranged and configured to generate a DC electric field within the mirror that urges any electrons or reactant ions entering the mirror through the opening to be reflected back out of the mirror through the opening. The mirror may comprise a plurality of electrodes that are spaced apart and voltage supplies configured to apply different DC voltages to different respective ones of these electrodes so as to generate the DC electric field that reflects the electrons or reactant ions. Substantially all of the electrodes of the mirror may be maintained at voltages of the same polarity.

The use of at least one electrostatic mirror for trapping the electrons or reactant ions is advantageous as the electrostatic mirror focusses the electrons or reactant ions (orthogonal to the direction of reflection), which prevents the cloud of electrons or reactant ions from expanding too much in the reaction region. For example, the mirrors may be configured so that the geometric magnification of the electron beam, or reactant ion beam, does not increase significantly on successive reflections. The use of at least one electrostatic mirror has been found to be a more efficient way of trapping the electrons or reactant ions than the use of simple blocking electrodes.

Said trapping may cause the electrons or reactant ions to oscillate through the reaction region primarily in a first dimension, and the analyte ions are conveyed through the reaction region substantially along the first dimension.

At least one electrostatic mirror may be used to trap the electrons or reactant ions in the reaction region by reflecting the electrons or reactant ions in the first dimension, and the analyte ions may be passed into and through the mirror along an axis that is substantially in the first dimension.

For example, two electrostatic mirrors may be used to trap the electrons or reactant ions in the reaction region by reflecting the electrons or reactant ions in the first dimension.

As the analyte ions may be transmitted into the first side of the reaction region travelling in the first dimension, this enables analyte ions to pass through the turning points at which the electrons or reactant ions are reflected. As described elsewhere herein, this may be beneficial as the electrons or reactant ions have low kinetic energies at these points, and hence higher probabilities of reacting with the analyte ions.

Alternatively, said trapping causes the electrons or reactant ions to oscillate through the reaction region primarily in a first dimension, and the analyte ions may be conveyed into and through the reaction region along an axis that is substantially orthogonal to the first dimension.

At least one electrostatic mirror may be used to trap the electrons or reactant ions in the reaction region by reflecting the electrons or reactant ions in the first dimension, and the analyte ions may be passed into and through the mirror along an axis that is substantially orthogonal to the first dimension.

The analyte ions may pass through a location within the mirror at which the oscillating electrons or reactant ions are turned around in the first dimension.

Alternatively, the analyte ions may pass through the reaction region at a location where the oscillating electrons or reactant ions are not being turned around. For example, the analyte ions may pass through the reaction region at a location between the turning points of the oscillating electrons or reactant ions.

In the methods disclosed herein, the analyte ions may be conveyed into the reaction region with sufficient kinetic energy such when the analyte ions react with the electrons or reactant ions within the reaction region to form fragment and/or product ions, at least some of these fragment and/or product ions, and optionally unreacted analyte ions, have sufficient kinetic energy to exit the reaction region without being trapped in the reaction region. In other words, at least some of the fragment and/or product ions, and optionally the unreacted analyte ions, may not be trapped by the DC electric fields that perform said trapping of the electrons or reactant ions.

For example, if the electrons or reactant ions are trapped between electrostatic mirrors, the analyte ions may be conveyed into the reaction region with sufficient kinetic energy that said at least some of the fragment and/or product ions, and optionally the unreacted analyte ions, pass through and out of at least one of the electrostatic mirrors.

The method may comprise trapping the analyte ions such that they repeatedly pass through the reaction region in which the electrons and reactant ions are located.

The step of trapping the analyte ions may comprise trapping the analyte ions between: (i) at least two electrostatic mirrors; (ii) at least two electrostatic sectors; or (iii) at least one electrostatic mirror and at least one electrostatic sector.

The analyte ions are preferably trapped by different electrostatic devices to those used to trap the electrons or reactant ions.

The method may comprise: trapping the electrons or reactant ions between first and second mirrors such that the electrons or reactant ions are oscillated back and forth between the first and second mirrors in the first dimension; and trapping the analyte ions between third and fourth mirrors such that the analyte ions are oscillated back and forth between the third and fourth mirrors and through the reaction region in which the electrons and reactant ions are trapped.

The third and fourth mirrors may reflect the analyte ions such that they oscillate in the first dimension, and the first and second mirrors may both be located between the third and fourth mirrors such that the oscillating analyte ions pass through the first and second mirrors in the first dimension.

Each of the first and second mirrors may have a first DC potential difference across it in the first dimension for reflecting the electrons or reactant ions, and each of the third and fourth mirrors may have a second, larger DC potential difference across it in the first dimension for reflecting the analyte ions.

All of the DC potentials applied to the first and second mirrors so as to form the first DC potential difference may have a magnitude of ≤10 V or ≤5 V.

These small potentials help ensure that the trajectories of the analyte ions are not adversely affected.

The first potential difference may therefore be ≤10 V or ≤5 V.

The second potential difference is required to be large enough to reflect the analyte ions, which may have significantly more kinetic energy than the electrons or reactant ions, e.g. due to the manner in which they are formed by the ion source and/or in order that the analyte ions can be transmitted through the first and second mirrors without their trajectories being significantly adversely affected.

The second potential difference is preferably at least 50v. For example, the second potential difference may be ≥60v, ≥70v, ≥80v, ≥90v, ≥100v, ≥120v, ≥140v, or ≥160v. The method may comprise: trapping the electrons or reactant ions such that the electrons or reactant ions are oscillated back and forth in a first dimension; and trapping the analyte ions such that they are oscillated back and forth through the reaction region along an axis that is at an angle to the first dimension.

For example, the axis may be substantially orthogonal to the first dimension.

The analyte ions may be trapped using electrostatic means such as those described herein. Alternatively, the analyte ions may be trapped using other means, such as devices that use RF voltages to confine or reflect the analyte ions, e.g. RF ion guides.

The method may comprise generating said electrons or reactant ions within said reaction region.

In the methods disclosed herein, the analyte ions and/or reactant ions may be multiply charged ions. For example, the charge state of the multiply charged analyte ions may be ≥3.

The use of highly charged analyte ions is advantageous as this reduces the density of electrons or reactant ions that are required to be trapped in the reaction region, and/or does not require the energy of the electrons or reactant ions to be as low, in order to achieve a given rate of reaction.

As such, higher charge states may be preferred, such as a charge state of at least 5, at least 10, at least 20, at least 40, at least 60, at least 80, or at least 100. Charge states of at least 100 have been found to be particularly beneficial.

The method may comprise maintaining the pressure in the reaction region between 10⁻⁵ and 10⁻¹ mbar. Such pressures enable the rate of collisions between the gas molecules and electrons or reactant ions to be low enough to avoid significant losses, whilst high enough to help reduce the thermal energy of the electrons or reactant ions.

The analyte ions may react with the electrons or reactant ions such that the analyte ions dissociate to form fragment ions and/or so that the analyte ions become charge-reduced analyte ions; and the method may further comprise mass analysing the fragment ions and/or charge-reduced analyte ions, or ions derived therefrom, using a mass analyser so as to obtain mass spectral data.

The ions may be mass analysed within the reaction region, such as by using an inductive or capacitive ion detector. Alternatively, the fragment ions and/or charge-reduced analyte ions (and any unreacted analyte ions) may be transmitted out of the reaction region to a downstream mass analyser that mass analyses the fragment ions and/or charge-reduced analyte ions, or ions derived therefrom.

The method may comprise providing a known species of molecules in the reaction region and reacting these molecules with the electrons or reactant ions so as to form calibrant ions having a known mass to charge ratio; mass analysing the calibrant ions in the mass analyser so as to measure their mass to charge ratio; and calibrating said mass spectral data based on the difference between the known and measured mass to charge ratios for the calibrant ions.

The electrons or reactant ions may be confined within the reaction device without using any RF electric fields or magnetic fields.

By not using magnets to confine the electrons or reactant ions within the reaction region, the complexity and cost of the method may be relatively low. For example, magnetic fields may cause the passage of the electrons, reactant ions or analyte ions to curve, which can be problematic. Additionally, magnetic confinement can elevate space-charge effects, which may affect the trajectories and focussing of ions and electrons. Also, the stability of magnetic fields may vary with temperature.

The present invention also provides a mass and/or ion mobility spectrometer that is configured to perform any of the methods described herein.

Accordingly, the present invention provides a mass and/or ion mobility spectrometer comprising: an ion source for generating analyte ions; an electrostatic trap for trapping electrons or reactant ions within a reaction region with DC electric fields; and at least one ion guiding device for guiding the analyte ions into a first side of the electrostatic trap such that the analyte ions pass through the reaction region inside the electrostatic trap, and wherein the electrostatic trap is configured to allow ions resulting from reactions between the analyte ions and the electrons or reactant ions to exit a second side of the electrostatic trap that is opposite the first side.

As mentioned above, the spectrometer may be configured to perform any of the methods described herein.

Accordingly, the electrostatic trap may comprise: (i) at least two electrostatic mirrors; (ii) at least two electrostatic sectors; or (iii) at least one electrostatic mirror and at least one electrostatic sector.

The electrostatic trap may be configured to causes the electrons or reactant ions to oscillate through the reaction region primarily in a first dimension, and the at least one ion guiding device may be arranged to guide the analyte ions through the reaction region substantially along the first dimension. For example, at least one electrostatic mirror may be used to trap the electrons or reactant ions in the reaction region by reflecting the electrons or reactant ions in the first dimension, and the analyte ions may be passed into and through the mirror along an axis that is substantially in the first dimension. Two electrostatic mirrors may be used to trap the electrons or reactant ions in the reaction region by reflecting the electrons or reactant ions in the first dimension.

The electrostatic trap may be configured to cause the electrons or reactant ions to oscillate through the reaction region primarily in a first dimension, and the at least one ion guiding device is arranged and configured to guide the analyte ions through the reaction region along an axis that is substantially orthogonal to the first dimension and through a location within the electrostatic trap at which the oscillating electrons or reactant ions are turned around.

The electrostatic trap may comprise at least one electrostatic mirror and the at least one ion guiding device may be arranged to guide the analyte ions through the mirror.

Alternatively, the at least one ion guiding device may be arranged to guide the analyte ions through the reaction region at a location where the oscillating electrons or reactant ions are not being turned around. For example, the at least one ion guiding device may be arranged to cause the analyte ions to pass through the reaction region at a location between the turning points of the oscillating electrons or reactant ions.

The spectrometer may be configured to cause the analyte ions to be conveyed into the reaction region with sufficient kinetic energy such when the analyte ions react with the electrons or reactant ions within the reaction region to form fragment and/or product ions, at least some of these fragment and/or product ions, and optionally unreacted analyte ions, have sufficient kinetic energy to exit the reaction region without being trapped in the reaction region. For example, the spectrometer may have voltage sources that are configured to apply voltages to electrodes of the spectrometer in order to provide the analyte ions with said sufficient kinetic energy.

Alternatively, the at least one ion guiding device may be arranged and configured to trap the analyte ions such that they repeatedly pass through the reaction region in which the electrons and reactant ions are located.

The at least one ion guiding device may comprise: (i) at least two electrostatic mirrors; (ii) at least two electrostatic sectors; or (iii) at least one electrostatic mirror and at least one electrostatic sector.

The analyte ions are preferably trapped by different electrostatic devices to those used to trap the electrons or reactant ions.

The electrostatic trap may comprise first and second mirrors for trapping the electrons or reactant ions such that they are oscillated back and forth between the first and second mirrors in the first dimension; wherein the at least one guiding device comprises third and fourth mirrors for trapping the analyte ions such that they are oscillated back and forth between the third and fourth mirrors and through the reaction region; and wherein the third and fourth mirrors are arranged and configured to reflect the analyte ions such that they oscillate in the first dimension, and wherein the first and second mirrors are both located between the third and fourth mirrors such that the oscillating analyte ions pass through the first and second mirrors in the first dimension.

The spectrometer may have as voltage supplies configured to apply voltages to electrodes of each of the first and second mirrors such that each of these mirrors has a first DC potential difference across it in the first dimension for reflecting the electrons or reactant ions. The spectrometer may also have voltage supplies configured to apply voltages to electrodes of each of the third and fourth mirrors such that each of these mirrors has a second, larger DC potential difference across it in the first dimension for reflecting the analyte ions.

The voltages applied to the electrodes of the first and second mirrors so as to form the first DC potential difference may have a magnitude of ≤10 V or ≤5 V.

The voltages applied to the electrodes of the third and fourth mirrors so as to form the second DC potential difference may have a magnitude of at least 50v.

The spectrometer may have one or more vacuum pumps in communication with the reaction region that are configured to maintain the pressure in the reaction region between 10⁻⁵ and 10⁻¹ mbar.

The spectrometer may comprise a mass analyser for mass analysing the fragment ions and/or charge-reduced analyte ions, or ions derived therefrom, so as to obtain mass spectral data.

The ions may be mass analysed within the reaction region, such as by using an inductive or capacitive ion detector. Alternatively, the fragment ions and/or charge-reduced analyte ions (and any unreacted analyte ions) may be transmitted out of the reaction region to a downstream mass analyser that mass analyses the fragment ions and/or charge-reduced analyte ions, or ions derived therefrom.

Methods and spectrometers have been described in which analyte ions are conveyed into a first side of the reaction region and through the reaction region such that they react with the electrons or reactant ions, and the resulting ions are allowed to exit the reaction region through a second side of the reaction region that is opposite the first side. However, it is contemplated that the resulting ions may alternatively be caused to exit the reaction region through the first side of the reaction region, e.g. in the embodiments in which the ions are reflected between mirrors.

### BRIEF DESCRIPTION OF THE DRAWINGS

Various embodiments of the present invention will now be described, by way of example only, and with reference to the accompanying drawings in which:

FIG. 1 illustrates a schematic of a reaction device according to an embodiment of the present invention;

FIG. 2 shows an embodiment that is the same as that in FIG. 1, except that the analyte ions are transmitted along a different axis through the reaction device;

FIG. 3 shows an embodiment in which the analyte ions and reactant ions or electrons are simultaneously trapped within the reaction device along the same axis;

FIG. 4 shows an embodiment in which the analyte ions and reactant ions or electrons are simultaneously trapped within the reaction device along different axes;

FIG. 5 shows an embodiment that is the same as that in FIG. 1, except that the mirrors that trap the electrons or reactant ions have a different configuration;

FIG. 6 shows an embodiment in which the electrons or reactant ions are trapped by electrostatic sectors; and

FIG. 7 shows a schematic of a mass spectrometer according to an embodiment of the present invention.

### DETAILED DESCRIPTION

Embodiments of the present invention provide an ion-electron or ion-ion reaction device for reacting analyte ions with either electrons or reactant ions. The electrons or reactant ions may be confined within the reaction device without using any RF electric fields or magnetic fields. For example, the electrons or reactant ions may be confined using only DC electric fields. The analyte ions may also be trapped within the reaction device whilst they react with the electrons or reactant ions. Alternatively, the analyte ions may simply be transmitted through the reaction device in which the electrons or reactant ions are trapped, such that the reactions may take place without trapping the analyte ions within the reaction device.

In the embodiments where the analyte ions are reacted with trapped electrons, the analyte ions may be positively charged ions. In the embodiments where the analyte ions are reacted with trapped reactant ions, the analyte ions and reactant ions are preferably oppositely charged. For example, the analyte ions may be positive ions and the reactant ions may be negative ions, or vice versa.

The reaction device may be used to react the analyte ions with the electrons or reactant ions so as to cause charge reduction of the analyte ions and/or to cause dissociation of the analyte ions into fragment ions (e.g. ECD or ETD).

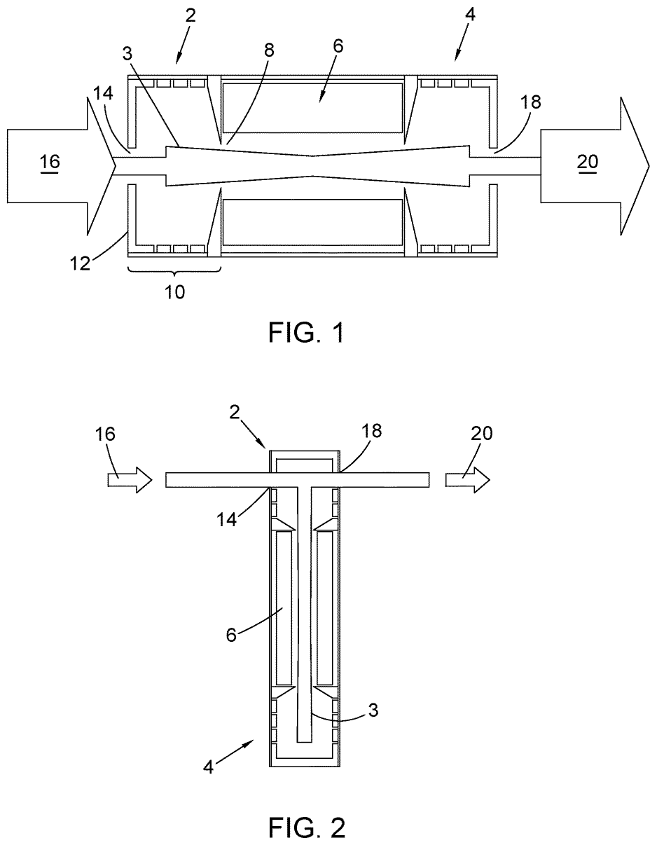

FIG. 1 illustrates a schematic of a reaction device according to an embodiment of the present invention. The reaction device comprises a first mirror 2 for reflecting electrons or reactant ions 3 and a second mirror 4 for reflecting the electrons or reactant ions 3. The mirrors may be spaced apart from each other by a flight region 6. The mirrors are arranged and configured so as to cause the electrons or reactant ions to be repeatedly reflected back and forth between the two mirrors, in a first dimension, such that the electrons or reactant ions are trapped in the first dimension. Such mirrors for reflecting charged particles are known, e.g. ion mirrors such as reflectrons.

Each mirror has an opening 8 at one of its ends, in the first dimension, for receiving the electrons or reactant ions. The mirror also has electrodes and voltage supplies arranged and configured to generate a DC electric field within the mirror that urges any electrons or reactant ions entering the mirror through the opening to be reflected back out of the mirror through the opening. For example, the mirror may comprise a plurality of electrodes 10 that are spaced along the first dimension and voltage supplies configured to apply different DC voltages to different respective ones of these electrodes so as to generate the DC electric field that reflects the electrons or reactant ions. For instance, if it is electrons or negative reactant ions that are trapped between the mirrors then, within each mirror, progressively more negative DC voltages may be applied to the electrodes as a function of distance away from the opening 8. Conversely, if it is positive reactant ions that are trapped between the mirrors then, within each mirror, progressively more positive DC voltages may be applied to the electrodes as a function of distance away from the opening.

Each mirror may have an end cap 12 at the opposite end, in the first dimension, to the opening 8. The end cap may be one of the electrodes 10 that has a voltage applied to it so as to reflect the electrons or reactant ions. However, it is contemplated that an end cap electrode may not be provided.

It will be appreciated that the voltages that are applied to the electrodes of the mirror for reflecting the electrons or reactant ions also serve to confine the electrons or reactant ions within the mirror in the dimensions orthogonal to the first dimension. If the flight region 6 is provided between the mirrors, the flight region may be provided by arranging one or more electrodes to extend between the mirrors. For example, a tubular electrode or other ion guiding electrodes may be arranged between the mirrors. One or more DC voltage may be applied to the one or more electrodes so as to confine the electrons or reactant ions in the dimensions orthogonal to the first dimension as they are reflected between the mirrors. For example, the one or more electrodes may be maintained at the same voltages as the electrodes that define the entrance openings to the mirrors such that there is substantially no axial electric field in the flight region.

The first mirror includes an analyte entrance aperture 14 for receiving the analyte ions 16 into the reaction device such that the analyte ions are transmitted into the region in which the electrons or reactant ions are trapped, thereby causing the analyte ions to react with the electrons or reactant ions and dissociate to produce fragment ions and/or produce other product ions such as charge-reduced analyte ions or adduct ions. The second mirror 4 includes an exit aperture 18 for allowing the product ions 20 to exit the reaction device.

In the embodiment shown, the entrance aperture 14 and exit aperture 18 are arranged such that the axis through these apertures extends along the first dimension through the region in which the electrons or reactant ions are trapped. As such, the analyte ions can be urged into the entrance aperture with sufficient energy in the first dimension such that the fragment and/or product ions derived therefrom pass out of the exit aperture. As described above, the analyte ions (and the fragment and/or product ions derived from them) preferably have the opposite polarity to the trapped electrons or reactant ions. As such, the voltages that are applied to the mirrors will produce DC electric fields that attract the analyte ions towards the mirror electrodes and that oppose the motion of the analyte ions through the first mirror 2 in the direction towards the exit aperture 18.

The analyte ions 16 are transmitted into the entrance aperture 14 with sufficient energy in the first dimension such that the analyte ions, and the fragment and/or product ions derived from them, are able to overcome the force due to the DC gradient in the first mirror 2 and travel to and out of the exit aperture 18. The DC voltages that are applied to the mirror electrodes 10 may have a relatively low amplitude in order to minimise these negative effects on the motion of the analyte ions. It will therefore be appreciated that the voltages applied to the electrodes of the reaction device and the energy of the analyte ions entering the reaction device are selected such that the analyte ions, and fragment and/or product ions derived therefrom, are not trapped (and/or substantially deflected) within the reaction device.

In the embodiment shown the entrance and exit apertures 14, 18 are provided in the end caps 12 of the first and second mirrors 2,4 respectively, although this need not be the case.

FIG. 2 shows another embodiment that is the same as that described in relation to FIG. 1, except that the analyte ions 16 are transmitted along a different axis through the reaction device. More specifically, the entrance aperture 14 and exit aperture 18 are arranged on opposing sides of the first mirror 2 such that the analyte ions interact with electrons or reactant ions 3 within the first mirror and then the resulting fragment and/or product ions 20 exit the reaction device from the first mirror. The analyte ions may be transmitted along an axis that is substantially orthogonal to the first dimension. This has various advantages, such as minimising losses of the fragment and/or product ions since their path length through the reaction device is shorter. Preferably the axis extends through the region within the mirror at which the electrons or reactant ions are turned. The kinetic energy of the trapped electrons or reactant ions is at a minimum at this location and so passing the analyte ions through this region provides a relatively high probability of the electrons or reactant ions reacting with the analyte ions.

Although analyte ions are only illustrated as being transmitted through the first mirror 2, it will be appreciated that analyte ions may also, or alternatively, be transmitted in a corresponding manner through the second mirror 3. For example, the analyte ions may be transmitted through the first mirror 2 and then guided so as to also pass through the second mirror 4. It is contemplated that the ions may be repeatedly cycled around such a device so as to repeatedly pass through the turning points of the electrons or reactant ions in both mirrors 2,4. Additionally, or alternatively, analyte ions may be transmitted through the flight region 6, if it is present, in a direction substantially orthogonal to the first dimension.

Referring back to FIG. 1, it will be appreciated that it is not straight-forward to trap the analyte ions in the same region that the reactant ions or electrons are trapped. Firstly, the analyte ions have the opposite polarity to the reactant ions or electrons and so it is difficult to confine both polarities when using only DC electric fields. Secondly, it is desired for the reactant ions or electrons to have low kinetic energy and so relatively small DC electric fields are used to confine these ions. Such fields may not be suitable for confining the analyte ions if they analyte ions have a relatively high kinetic energy.

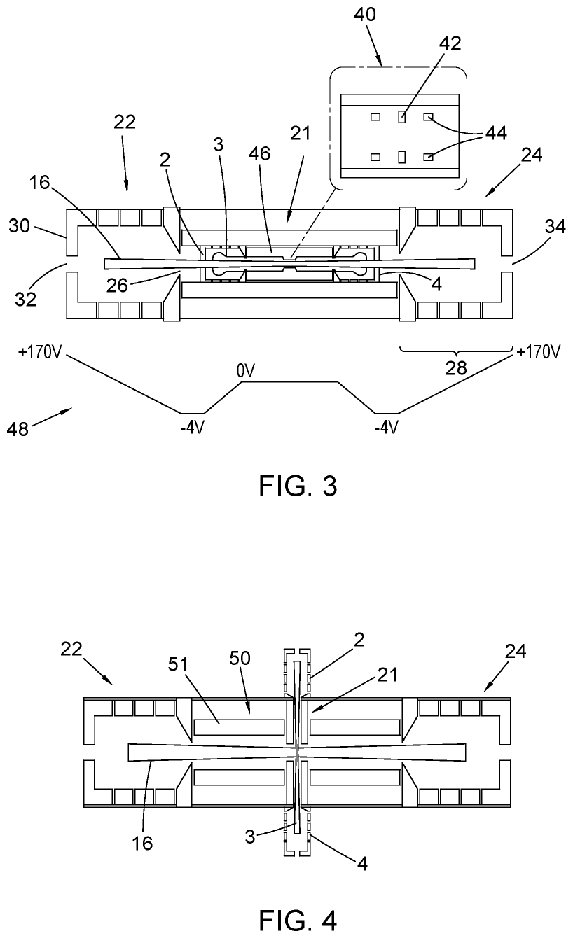

FIG. 3 shows an embodiment of the present invention for simultaneously trapping the analyte ions 16 and the reactant ions or electrons 3 within the reaction device. The reaction device comprises a first trap 21 for trapping the reactant ions or electrons 3. The first trap may be configured and operated in the same manner as the reaction device described in relation to FIG. 1, such that the reactant ions or electrons are trapped between the mirrors 2,4. The reaction device of FIG. 3 further comprises third and fourth mirrors 22,24 arranged, in the first dimension, on opposing ends of the first ion trap 21. The third and fourth mirrors are mirrors that reflect the analyte ions 16 back and forth between them, such that the ions pass through the first trap whilst passing between the mirrors 22,24.

Each of the third or fourth mirrors 22,24 may have a configuration corresponding to that of the first or second mirrors 2,4, except adapted for reflecting analyte ions 16 having a higher kinetic energy than the reactant ions or electrons 3. That is, each of the third and fourth mirrors has an opening at one of its ends 26, in the first dimension, for receiving the analyte ions from the first trap. Each of these mirrors 22,24 also has electrodes 28 and voltage supplies arranged and configured to generate an electric field, such as a DC electric field, within the mirror 22,24 that urges any analyte ions entering the mirror 22,24 through the opening 26 to be reflected back out of the mirror through the opening 26 and back into the first trap. For example, the mirror 22,24 may comprise a plurality of electrodes 28 that are spaced along the first dimension and voltage supplies configured to apply different voltages, such as DC voltages, to different respective ones of these electrodes so as to generate the electric field that reflects the analyte ions. For instance, if it is positive analyte ions that are trapped between the mirrors then, within each mirror 22,24, progressively more positive DC voltages may be applied to the electrodes as a function of distance away from the opening 26. Conversely, if it is negative analyte ions that are trapped between the mirrors 22,24 then, within each mirror, progressively more negative DC voltages may be applied to the electrodes as a function of distance away from the opening 26.

Each of the third and fourth mirrors may have an end cap 30 at the opposite end, in the first dimension, to its opening 26. The end cap may be one of the electrodes 28 that has a voltage applied to it so as to reflect the analyte ions. At least one of the mirrors 22,24 has an entrance aperture 32 for introducing analyte ions into the reaction device.

For example, analyte ions 16 may be introduced through an entrance aperture 32 in the end cap 30 of the third mirror 22. At least one of the mirrors 22,24 has an exit aperture for extracting fragment or product ions that are generated within the reaction device. The exit aperture may be the same aperture as the entrance aperture 32, or it may be another aperture such as an aperture 34 in the end cap of the fourth mirror 24.

In operation, reactant ions or electrons are introduced into the first trap 21, or are generated within the first trap. As shown by the expanded portion 40 of FIG. 3, in embodiments in which electrons are trapped in the first trap 21, the electrons 3 may be generated within the first trap by a thermal filament 42. The filament may generate electrons having a kinetic energy of, for example, a few electron volts. These electrons are then reflected back and forth between the mirrors 2,4 of the first trap in the manner described above, i.e. along an axis in the first dimension. The filament may be spaced apart from the axis in a direction orthogonal to the axis and the electrons that are generated by the filament may be urged onto the axis by one or more deflector electrodes 44 such that the electrons travel along the axis and are reflected by the mirrors. The density of the trapped electrons eventually builds up to a density that is sufficient to provide reactions with the analyte, such as ECD reactions. Alternatively, as described above, reactant ions may be trapped in the first trap rather than electrons.

Analyte ions are introduced into the reaction device through an entrance aperture 32 in the third mirror 22, as described above. The entrance aperture is arranged, and the injected analyte ions have sufficient kinetic energy, such that the analyte ions pass through the third mirror in the first dimension, through the entrance opening 26 of the third mirror, through the first trap 21 in which the reactant ions or electrons are trapped, and into the fourth mirror 24. As the analyte ions pass through the first trap they may react with the reactant ions or electrons so as to produce fragment ions or product ions such as charge-reduced analyte ions. The fragment or product ions, along with analyte ions that have not reacted with the reactant ions or electrons, then pass into the fourth mirror. The fourth mirror then reflects these ions in the first dimension such that they pass back into and through the first trap, and into the third mirror. The ions may then exit the reaction device, or the third and fourth mirrors may reflect the ions further times such that the above-described process is repeated, wherein each time the analyte ions are caused to pass back through the first trap they are able to react with the reactant ions or electrons.

Once the analyte ions have been transmitted through the first trap a sufficient number of times, i.e. after a sufficient duration for reacting with the reactant ions or electrons, the third and/or fourth mirror (or another part of the reaction device) may be switched so as to cause the fragment or product ions to be ejected from the reaction device, optionally along with any unreacted analyte ions, so that these ions may be mass analysed. For example, the electric field in the third and/or fourth mirror for reflecting ions may be altered so as to allow the ions to exit through an exit opening in the third and/or fourth mirror, such as through an opening 32,34 in the end cap electrode 30 of that mirror.

Alternatively, or additionally, to mass analysing the ions downstream of the reaction device, the ions may be mass analysed within the reaction device. For example, an ion detector may be arranged within the reaction device in order to determine the frequencies with which the trapped ion species oscillate between the third and fourth mirrors. The frequency with which an ion oscillates in this manner is indicative of its mass to charge ratio and so the spectrometer may have electrical circuitry configured to determine the mass to charge ratios of the ions that are trapped within the reaction device based on their detected frequencies of oscillation between the third and fourth mirrors. The ion detector may therefore be a Fourier transform ion detector.

The ion detector may be an inductive or capacitive detector having an electrode 46 on which a charge is induced each time that an ion oscillates passed the electrode. The signal induced at the electrode is detected and used to determine the frequencies with which the ions oscillate between the third and fourth mirrors. These frequencies are then used by the spectrometer to determine the mass to charge ratios of the ions. The electrode of the ion detector may be, for example, a plate electrode or a tubular electrode through which the ions pass as they oscillate. The electrode may be arranged between the third and fourth mirrors, within the first trap, such as within the flight region of the first trap. In this embodiment the inductive or capacitive detector has been described as comprising the electrode 46 that is arranged between the mirrors of the first trap. However, in order to minimise the electrode picking up a signal from the oscillating electrons or reactant ions, the inductive or capacitive detector may comprise one or more electrodes that are located axially outside of the first trap. For example, an electrode could be arranged between the first trap and the mirror 22, and/or between the first trap and the mirror 24, for picking up an ion signal due to the analyte ions and or the fragment or product ions derived therefrom. These electrodes could be chosen to be at ground electrical potential. If electrodes are provided on both sides of the first trap then the signals from these electrodes may be combined and analysed as a single signal, or amplified separately and analysed as two distinct signals.

Alternatively, or additionally, the ion detector may be an impact detector arranged within the path of the oscillating ions such that a portion of these ions impact on the detector during each oscillation. Again, the signal from the detector may be used to determine the frequencies with which the ions oscillate between the third and fourth mirrors and these frequencies may then be used by the spectrometer to determine the mass to charge ratios of the ions. The ion detector surface that the ions strike may be, for example, a microchannel plate.

As mentioned above, inductive or capacitive ion detectors may be used to detect an ion signal caused by ions oscillating within the device. The amplitude of the ion signal detected may be used to determine the masses of the ions, as is well known in charge detection mass spectrometry (CDMS).

FIG. 3 shows an example of a potential profile 48 that may be provided along the central axis of the reaction device whilst the analyte ions and the reactant ions or electrons are trapped within the reaction device. The example shown is for trapping negative reactant ions or electrons in the first trap and trapping positive analyte ions between the third and fourth mirrors. However, it will be appreciated that the polarity of the values of the potentials that are shown may be reversed in order to trap negative analyte ions and positive reactant ions. The magnitudes of the potential values shown may also be different, depending on the energies of the analyte ions and the reactant ions or electrons that are trapped.

As can be seen, each of the mirrors in the first trap has a relatively small potential difference across it for reflecting the reactant ions or electrons, whereas each of the third and fourth mirrors has a larger potential difference across it for reflecting the analyte ions. This is because the reactant ions or electrons are conditioned so as to have a relatively small kinetic energy in order to provide a relatively high probability or reacting with the analyte ions when they pass through the first trap, whereas the analyte ions have a higher kinetic energy. In the example shown, the flight region between the mirrors of the first trap is grounded at OV and a potential difference of 4V is provided across each of the mirrors for reflecting and trapping the reactant ions or electrons between them. It will be appreciated that the potential difference across each of these mirrors may be greater or smaller than that shown. For example, a potential difference having other values less than or equal to, for example, 5V or 10V may be used to trap electrons within the first trap, whereas a greater potential difference may be used to trap reactant ions within the first trap.

As described above, the analyte ions are required to pass through the mirrors 2,4 of the first trap in both directions. The electric potentials applied to the mirrors of the first trap are therefore preferably relatively small such that they do not substantially perturb the axial motion of the analyte ions as they pass through the first trap. The electrons or reactant ions that are trapped within the first trap will be charged and will therefore also have an electric potential, but the charge density of electrons or reactant ions that are trapped is such that the electric potential is negligible and substantially does not perturb the motion of the analyte ions through the first trap.

In the example shown, the third and fourth mirrors are designed to reflect analyte ions having an energy of 130V per charge. The potential at the entrance to each of the third and fourth mirrors is −4V and the potential at each end cap electrode is +170V.

However, other potential differences may be provided in order to provide a potential gradient that is suitable to reflect and trap the analyte ions. For example, if the analyte ions having a relatively high kinetic energy then a relatively high potential difference will be maintained across each of the third and fourth mirrors, whereas if the analyte ions having a lower kinetic energy then a lower potential difference may be maintained across each of the third and fourth mirrors.

FIG. 4 shows another embodiment, which is the same as that shown and described in relation to FIG. 3 except that the first trap 21 is arranged to reflect the electrons or reactant ions 3 along a first axis, whereas the third and fourth mirrors 22,24 are arranged to reflect the analyte ions 16 along a second axis that is at an angle to the first axis, where the first axis intersects the second axis such that the analyte ions are able to react with the electrons or reactant ions at the region the axes intersect. In this embodiment a field-free flight region may be provided between the mirrors in the first trap, a field-free flight region 50 may be provided between the third and fourth mirrors, and the axes may intersect in the field-free flight regions 6,50. Such an arrangement provides a reaction region in a relatively simple manner. It will be appreciated that the one of more electrodes forming the flight region 6 of the first trap 21 has openings along an axis orthogonal to the first axis so as to allow the analyte ions to pass through the first trap. Also, one or more electrode 52 may be provided between the first trap 21 and each of the third and fourth mirrors 22,24 for defining the flight region 50 along which the analyte ions travel. The fragment or product ions may be mass analysed in the manner described above, i.e. within the reaction device and/or external to the reaction device.

For example, the fragment or product ions (and/or analyte ions) may be mass analysed using an inductive or capacitive detector. In such embodiments the elongated electrode(s) of the inductive or capacitive detector extend along in the dimension that the fragment or product ions (and/or analyte ions) oscillate in, which is orthogonal to the dimension along which the electrons or reactant ions oscillate. As such, the signal picked up from the oscillating electrons or reactant ions is minimised. One such electrode may be arranged between the first trap and the mirror 22, and/or between the first trap and the mirror 24, for picking up an ion signal due to the analyte ions and/or the fragment or product ions derived therefrom. These electrodes could be chosen to be at ground electrical potential. If electrodes are provided on both sides of the first trap then the signals from these electrodes may be combined and analysed as a single signal, or amplified separately and analysed as two distinct signals.

Although the first axis is shown as being orthogonal to the second axis in FIG. 4, it is contemplated that the axes may be at other angles to each other provided that they intersect.

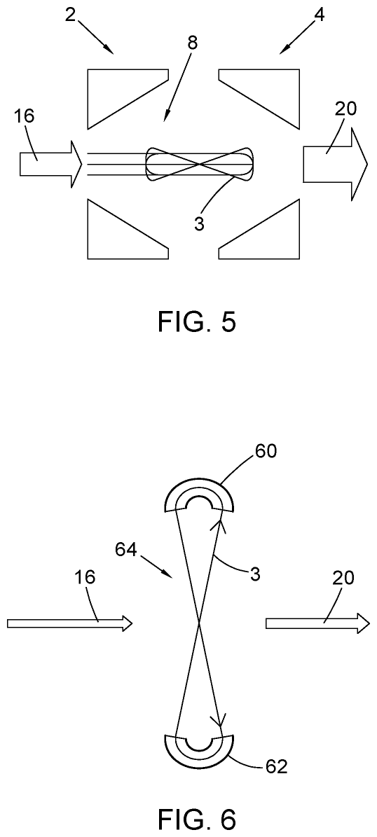

FIG. 5 shows another embodiment that is the same as that shown and described in relation to FIG. 1, except that the mirrors 2,4 that trap the electrons or reactant ions 3 have a different configuration. According to FIG. 5, the mirrors 2,4 still receive the electrons or reactant ions along an axis that extends though openings 8, but each mirror comprise one or more DC electrode having a surface that converges towards the axis as a function of distance away from the opening 8, so as to generate a DC field along the axis that reflects the electrons or reactant ions. For example, each mirror may have a conical internal surface that converges in a direction away from the opening so as to generate a DC field along the axis that reflects the electrons or reactant ions. Alternatively, each mirror may comprise a plurality elongated electrodes, such as rods or plates, that are arranged such that their internal surfaces converge in a direction away from the opening so as to generate a DC field along the axis that reflects the electrons or reactant ions.

The electron or reactant ion trapping arrangement described in relation to FIG. 5 may replace any of the electron or reactant ion trapping arrangements described elsewhere herein, such as in relation to FIGS. 1-4.

FIG. 6 shows another embodiment in which the electrons or reactant ions 3 are trapped by two electrostatic sectors 60,62. In the example shown, the electrons or reactant ions 3 enter the entrance to a first of the electrostatic sectors 60, are guided around a curved path within the sector, exit the first sector and then travel through a flight region 64 to the entrance to a second of the sectors 62. The electrons or reactant ions enter the entrance of the second sector 62, are guided around a curved path within the sector, exit the second sector and then travel through the flight region 64 to the entrance to the first sector. The electrons or reactant ions are therefore trapped by the sectors 60,62.

Analyte ions 16 are introduced into a region between the sectors through which the electrons or reactant ions pass as they travel between the sectors. At least some of the analyte ions react with the electrons or reactant ions 3 to produce fragment or product ions 20, in the manner described elsewhere herein. These fragment or product are then transmitted downstream. Although not shown, the analyte ions may be guided to the reaction region by an ion guide, and/or the fragment/product ions may be guided away from the reaction region by an ion guide. It is contemplated that the analyte ions and the fragment/product ions produced therefrom may be trapped such that they are repeatedly passed through the reaction region. For example, the trapping device for the electrons or reactant ions shown in FIG. 6 may replace that described in relation to FIG. 4.

The electrostatic sectors may be 2D sectors or they may be 3D sectors such as hemispherical sectors.

Furthermore, although two sectors are shown for trapping the electrons or reactant ions along a figure-of-eight flight path such that the electrons or reactant ions pass through the reaction region twice for each circuit through the sectors, it is contemplated that other configurations and numbers of sectors may be used, e.g. to trap the electrons or reactant ions along a flight path such that the electrons or reactant ions pass through the reaction region only once or greater than twice for each circuit through the sectors.

According to the embodiments herein, the trapping region in which the electrons or reactant ions are trapped is desirably held at a sub-atmospheric pressure that is relatively low, such that the rate of collisions between the gas and the electrons or reactant ions is relatively low. However, the gas pressure in this region is also desirably sufficiently high to help reduce the thermal energy of the electrons or reactant ions trapped therein. As such, the gas pressure in this region may be between 10⁻⁷ and 10⁻¹ mbar. The gas may be an inert gas,

Although embodiments have been described in which the trapped electrons are reacted with analyte ions, it is contemplated that the trapped electrons may alternatively or additionally react with the background gas molecules in the reaction region so as to ionise these gas molecules and form radical or non-radical cations and anions, e.g. via electron impact ionisation (El). Based on knowledge of what the gas comprises, the type of cations and anions that are generated may be predictable and hence the true mass to charge ratio of such ions may be known. As such, these cations or anions may be mass analysed by the same mass analyser that is used to mass analyse the fragment or product ions and hence may be used as calibration or lock-mass ions for calibration of the mass analyser, i.e. for correcting the mass to charge ratios of the ions detected by the mass analyser.

Alternatively, the radical or non-radical cations and anions may be trapped in the reaction region and react with the analyte ions.

Embodiments of the present invention may react analyte ions having relatively high charge states with the electrons or reactant ions. For relatively highly charged ions the probability of electron-ion interaction is relatively high, as the Thomson radius defining the area of capture/interaction increases with the square of the charge of the ion.

For example, in an ion-electron interaction event, the Thomson radius that defines the capture cross-sectional area increases as a function of the charge state of the ion squared and is inversely proportional to the kinetic energy squared of the electron-ion pair (in the centre of mass frame). For instance, if the charge state of the analyte ion increases from 3+ to 300+, the capture cross-sectional area increases by 10,000. As such, relatively high charge state analyte ions only require a relatively low density of electrons in order to obtain a certain rate of ion-electron reactions, whereas analyte ions having lower charge states require higher densities of electrons in order to obtain the same rate of ion-electron reactions. As such, the use of highly charged analyte ions means that the conventional, relatively complex, techniques of trapping electrons with magnetic and RF fields in order to enhance the density of low energy electrons can be avoided.

Also, relatively low charge state analyte ions require relatively low energy electrons in order to obtain a certain rate of ion-electron reactions, whereas analyte ions having higher charge states do not require the electrons to have such low energies in order to obtain the same rate of ion-electron reactions. As such, the use of analyte ions having relatively high charge states alleviates the design constraints, since trapping low energy electrons is more challenging than trapping higher energy electrons. Also, as relatively highly charge analyte ions have a relatively high probability of reacting with the electrons, the region in which they react may be relatively small. This allows more freedom in how the analyte ions and electrons are caused to intersect. For example, a beam of the electrons may be trapped along an axis and the analyte ions may be passed orthogonally through the beam, rather than the analyte ions having to pass along the axis of the beam.

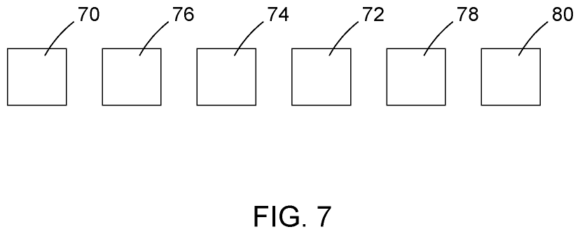

FIG. 7 shows a schematic of an embodiment of a mass spectrometer that includes a reaction device as described herein. The spectrometer comprises an ion source 70 and the reaction device 72. The ion source may be an electrospray ionisation (ESI) ion source. Any other type of ion source may be used instead of an ESI ion source although, as described above, ion sources that generate analyte ions having high charge states are preferred. The analyte ions generated in the ion source, or ions derived therefrom, are transmitted into the reaction device. The ions may be filtered, e.g. in a quadrupole mass filter 74, and/or separated by mobility in an ion mobility separator 76 prior to entering the reaction device. The ions that are transmitted into the reaction device are reacted with the electrons or reactant ions therein, e.g. via ECD or ETD reactions, so as to produce fragment, product ions, or charge-reduced analyte ions. These ions, along with any unreacted analyte ions, may be mass analysed within the reaction device in a manner as has been described above. Alternatively, these ions may be ejected or released from the reaction device and transmitted downstream for analysis. For example, these ions may be analysed so as to determine their ion mobilities through an ion mobility separator 78 and/or to determine their mass to charge ratios using a mass analyser 80 downstream of the reaction device.

Although the present invention has been described with reference to various embodiments, it will be understood by those skilled in the art that various changes in form and detail may be made without departing from the scope of the invention as set forth in the accompanying claims.

For example, although certain devices have been described for trapping the electrons or reactant ions, and optionally for trapping the analyte ions, it will be appreciated that various other forms of device may be used. For example, other forms or electrostatic traps, electrostatic mirrors or electrostatic sectors may be used to trap the electrons or reactant ions. These devices may be arranged and configured to trap electrons or reactant ions at low kinetic energies. As the trapped electrons or reactant ions are at low energies, the electrodes of the device are only required to have low DC voltages in order to maintain the trapping (e.g. ≤5V). As such, the analyte ions are able to be transmitted through the trapped electrons or reactant ions with higher kinetic energies (e.g. ≥100eV) such that the trajectories of the analyte ions are substantially not affected, or only slightly modified, by the trapping of the electrons or reactant ions. This greatly simplifies the operation of the reaction device. Analyte ions having lower kinetic energy may be used, e.g. for increasing the reaction efficiency, but their trajectories are more likely to be deflected by the fields that trap the electrons or reactant ions. In such embodiments, additional electric fields may be provided to correct the deflected trajectories of the analyte ions.

The devices for trapping the electrons or reactant ions, and optionally for trapping the analyte ions, may be grid-free devices. This avoids scattering of the particles and losses.

The devices for trapping the electrons or reactant ions, and optionally for trapping the analyte ions, may be planar or cylindrical mirrors/reflectrons, or may use quadratic or quadro-logarithmic fields.

Although embodiments have been described in which the mirrors for trapping the analyte ions are DC-only devices, it is contemplated that such devices may additionally or alternatively use RF fields or even magnetic fields, provided that the electrons or reactant ions are not subjected to these fields.

Embodiments have been described in which the analyte ions are of the opposite polarity to the reactant ions or electrons so as to produce the reactions. For example, the reaction may be ECD, ETD, negative-ETD (known as nETD) in which negative analyte ions react with positive reactant ions, or EID. However, the invention also applies to reactions between analyte ions that have the same polarity as the reactant ions or electrons, e.g. to electron detachment dissociation (EDD) reactions between negative analyte ions and higher energy electrons.

1. A method of mass and/or ion mobility spectrometry comprising:
trapping electrons or reactant ions within a reaction region with DC electric fields;
conveying analyte ions into a first side of the reaction region and through the reaction region such that they react with the electrons or reactant ions, and allowing the resulting ions to exit the reaction region through a second side of the reaction region that is opposite the first side.

2. The method of claim 1, wherein said trapping comprises trapping the electrons or reactant ions between: (i) at least two electrostatic mirrors; (ii) at least two electrostatic sectors; or (iii) at least one electrostatic mirror and at least one electrostatic sector.

3. The method of claim 1 wherein said trapping causes the electrons or reactant ions to oscillate through the reaction region primarily in a first dimension, and the analyte ions are conveyed through the reaction region substantially along the first dimension.

4. The method of claim 3, where at least one electrostatic mirror is used to trap the electrons or reactant ions in the reaction region by reflecting the electrons or reactant ions in the first dimension, and wherein the analyte ions are passed into and through the mirror along an axis that is substantially in the first dimension.

5. The method of claim 1, wherein said trapping causes the electrons or reactant ions to oscillate through the reaction region primarily in a first dimension, and the analyte ions are conveyed into and through the reaction region along an axis that is substantially orthogonal to the first dimension.

6. The method of claim 5, where at least one electrostatic mirror is used to trap the electrons or reactant ions in the reaction region by reflecting the electrons or reactant ions in the first dimension, and wherein the analyte ions are passed into and through the mirror along an axis that is substantially orthogonal to the first dimension.

7. The method of claim 6, wherein the analyte ions pass through a location within the mirror at which the oscillating electrons or reactant ions are turned around in the first dimension.

8. The method of claim 1, wherein the analyte ions are conveyed into the reaction region with sufficient kinetic energy such when the analyte ions react with the electrons or reactant ions within the reaction region to form fragment and/or product ions, at least some of these fragment and/or product ions, and optionally unreacted analyte ions, have sufficient kinetic energy to exit the reaction region without being trapped in the reaction region.

9. The method of claim 1, comprising trapping the analyte ions such that they repeatedly pass through the reaction region in which the electrons and reactant ions are located.

10. The method of claim 9, comprising:
trapping the electrons or reactant ions between first and second mirrors such that the electrons or reactant ions are oscillated back and forth between the first and second mirrors in the first dimension; and
trapping the analyte ions between third and fourth mirrors such that the analyte ions are oscillated back and forth between the third and fourth mirrors and through the reaction region in which the electrons and reactant ions are trapped.

11. The method of claim 10, wherein the third and fourth mirrors reflect the analyte ions such that they oscillate in the first dimension, and wherein the first and second mirrors are both located between the third and fourth mirrors such that the oscillating analyte ions pass through the first and second mirrors in the first dimension.

12. The method of claim 11, wherein each of the first and second mirrors has a first DC potential difference across it in the first dimension for reflecting the electrons or reactant ions, and wherein each of the third and fourth mirrors has a second, larger DC potential difference across it in the first dimension for reflecting the analyte ions.

13. (canceled)

14. The method of claim 1, comprising:
trapping the electrons or reactant ions such that the electrons or reactant ions are oscillated back and forth in a first dimension; and
trapping the analyte ions such that they are oscillated back and forth through the reaction region along an axis that is at an angle to the first dimension.

15. The method of claim 1, wherein the analyte ions and/or reactant ions are multiply charged ions.

16. The method of claim 1, wherein the analyte ions react with the electrons or reactant ions such that the analyte ions dissociate to form fragment ions and/or so that the analyte ions become charge-reduced analyte ions; and wherein the method further comprises mass analysing the fragment ions and/or charge-reduced analyte ions, or ions derived therefrom, using a mass analyser so as to obtain mass spectral data.

17. The method of claim 16, comprising providing a known species of molecules in the reaction region and reacting these molecules with the electrons or reactant ions so as to form calibrant ions having a known mass to charge ratio; mass analysing the calibrant ions in the mass analyser so as to measure their mass to charge ratio; and calibrating said mass spectral data based on the difference between the known and measured mass to charge ratios for the calibrant ions.

18. The method of claim 1, wherein the electrons or reactant ions are confined within the reaction device without using any RF electric fields or magnetic fields.

19. A mass and/or ion mobility spectrometer comprising:
an ion source for generating analyte ions;
an electrostatic trap for trapping electrons or reactant ions within a reaction region with DC electric fields; and
at least one ion guiding device for guiding the analyte ions into a first side of the electrostatic trap such that the analyte ions pass through the reaction region inside the electrostatic trap, and wherein the electrostatic trap is configured to allow ions resulting from reactions between the analyte ions and the electrons or reactant ions to exit a second side of the electrostatic trap that is opposite the first side.

20. The spectrometer of claim 19, wherein the electrostatic trap is configured to cause the electrons or reactant ions to oscillate through the reaction region primarily in a first dimension, and the at least one ion guiding device is arranged and configured to guide the analyte ions through the reaction region along an axis that is substantially orthogonal to the first dimension and through a location within the electrostatic trap at which the oscillating electrons or reactant ions are turned around.

21. The spectrometer of claim 19, wherein the electrostatic trap comprises first and second mirrors for trapping the electrons or reactant ions such that they are oscillated back and forth between the first and second mirrors in the first dimension;
wherein the at least one guiding device comprises third and fourth mirrors for trapping the analyte ions such that they are oscillated back and forth between the third and fourth mirrors and through the reaction region; and
wherein the third and fourth mirrors are arranged and configured to reflect the analyte ions such that they oscillate in the first dimension, and wherein the first and second mirrors are both located between the third and fourth mirrors such that the oscillating analyte ions pass through the first and second mirrors in the first dimension.
